(19) United States
(12) Patent Application Publication
(10) Pub. No.: US 2015/0130394 A1
(43) Pub. Date: May 14, 2015

(54) ADAPTIVE SOLAR ENERGY HARVESTING DEVICE

(71) Applicants: Yun-Shan Chang, San Jose, CA (US); Da-Wei Lin, New Taipei City (TW)

(72) Inventor: YUN-SHAN CHANG, SAN JOSE, CA (US)

(73) Assignee: Da-Wei Lin, New Taipei City (TW)

(21) Appl. No.: 14/141,614

(22) Filed: Dec. 27, 2013

(30) Foreign Application Priority Data
Nov. 13, 2013 (TW) 102141253

(51) Int. Cl. H02J 7/35; H02J 7/00

(52) U.S. Cl. CPC H02J 7/35; H02J 7/0029; H02J 7/0052
USPC 320/101

(57) ABSTRACT

The present disclosure provides an adaptive solar energy harvesting device comprising a solar energy receiving unit, a voltage converter and a charging power controller. The voltage converter has an input terminal and an output terminal. The input terminal of the voltage converter is coupled to the solar energy receiving unit, and receives the electric energy generated by the solar energy receiving unit through the input terminal. The charging power controller is coupled to the output terminal of the voltage converter, and senses the supply voltage at the output terminal of the voltage converter. The charging power controller generates a charging voltage and a charging current to charge at least an electricity storage unit. The charging power controller adjusts the charging voltage and the charging current according the feed-forward control related to the supply voltage at the output terminal of the voltage converter.

### BACKGROUND OF THE INVENTION

1. Field of the Invention

The instant disclosure relates to a solar energy harvesting device; in particular, to an adaptive solar energy harvesting device.

2. Description of Related Art

The energy which is existed on earth falls into shortage yearly by yearly. Such as coal; petroleum; ethanol; nuclear energy; water energy; geo-thermal energy; wind energy; and renewable bio-energy etc., all encounter different drawbacks and difficult reasons on cost; safety; green; and productivity. Because of the usage and human population are increased rapidly, it is inevitable to have a clean; reliable; and cost effective energy for human being to utilize it daily. There are two candidates which can meet the previous criteria—nuclear fusion and solar energy. The nuclear fusion is good but it still cannot go to commercialize due to technical barrier, while solar is the very candidate to fulfill the determinate role on energy sources. Although solar energy harvesting is a feasible and reasonable energy source as compared to other existed candidates, there are some other issues to be breakthrough to make it become a mighty energy source. The issues are solar cells efficiency and photo-voltaic energy harvest/transfer efficiency. III-V compound cell with new quantum dot technology shows amazing efficiency over 70% photo-voltaic conversion but it can be only used on special applications due to its extraordinary fabrication cost. Currently commercial solar cell is silicon based with about up to 21% photo-voltaic conversion efficiency. Even there are some other type solar cells, for example organic polymer and II-VI compound are announced but the reliability; durability; and cost make it is unable to be a suitable candidate. Lately most of solar cell manufactures invest more and more on the improvement of silicon-based solar cells with light intensity collection; incident light recycling; multiple-path absorption, etc. So far, there is not a good photo-voltaic transfer design to accommodate the harvested solar energy transfer into stored voltaic energy and/or usable electric energy. Most of design needs to be under high light incidence to trigger the harvesting energy transfer, for example more than 30-50K Lux.

Present solutions and their drawbacks are described in the following. Existed solar energy harvesting solutions are unable to do energy harvesting under low-light incidence, thus it always needs sufficient light to trigger energy harvesting. The reason is the loading line problem. The heavy loading line to drain out the current is much more than the supply from solar panel. It results the depletion of solar supply current and boost's output voltage sustainment. The loss strength of converted voltage the energy harvest will be terminated no matter how strong the irradiation of incidence light intensity. Hence the existed harvesting needs a maximum power tracking system which is using the complicated feedback design to have the Maximum Power Point Tracking (MPPT).

Please refer to FIG. 1 showing a curve diagram of the output current (Iout) and the output voltage (V) of a conventional solar cell. The existed MPPT is track the maximum power point P as shown in FIG. 1. The existed MPPT is power consumed and slow response with non-accurate tracking results. And under low light incidence the supply current drop rapidly the MPPT becomes incapable to do correct tracking hence it results collapse of solar energy harvest.

### SUMMARY OF THE INVENTION

The object of the instant disclosure is to offer an adaptive solar energy harvesting device utilizing the feed-forward control to control the charging current and the charging voltage when charging the electricity storage unit.

In order to achieve the aforementioned objects, according to an embodiment of the instant disclosure, an adaptive solar energy harvesting device is provided. The adaptive solar energy harvesting device comprises a solar energy receiving unit, a voltage converter and a charging power controller. The voltage converter has an input terminal and an output terminal. The input terminal of the voltage converter is coupled to the solar energy receiving unit. The voltage converter receives the electricity from the solar energy receiving unit through the input terminal. The charging power controller is coupled to the output terminal of the voltage converter. The charging power controller senses a supply voltage of the output terminal of the voltage converter and generates a charging voltage and a charging current to charge at least an electricity storage unit. The charging power controller adjusts the charging voltage and the charging current according the feed-forward control related to the supply voltage at the output terminal of the voltage converter.

In summary, the adaptive solar energy harvesting device utilizes feed-forward control to control the charging current and the charging voltage when charging the electricity storage unit, in order to convert and store electricity under low light incidence.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a curve diagram of the output current and the output voltage of a conventional solar cell;

FIG. 2 shows a circuit diagram of an adaptive solar energy harvesting device according to an embodiment of the instant disclosure;

FIG. 3 shows a curve diagram of the loading line of the solar cell for the adaptive solar energy harvesting device according to an embodiment of the instant disclosure;

FIG. 4 shows a circuit diagram of charging power controller according to an embodiment of the instant disclosure; and

FIG. 5 shows a curve diagram of the charging current and the charging voltage when the adaptive solar energy harvesting device charges the electricity storage unit according to an embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

[An Embodiment of the Adaptive Solar Energy Harvesting Device]

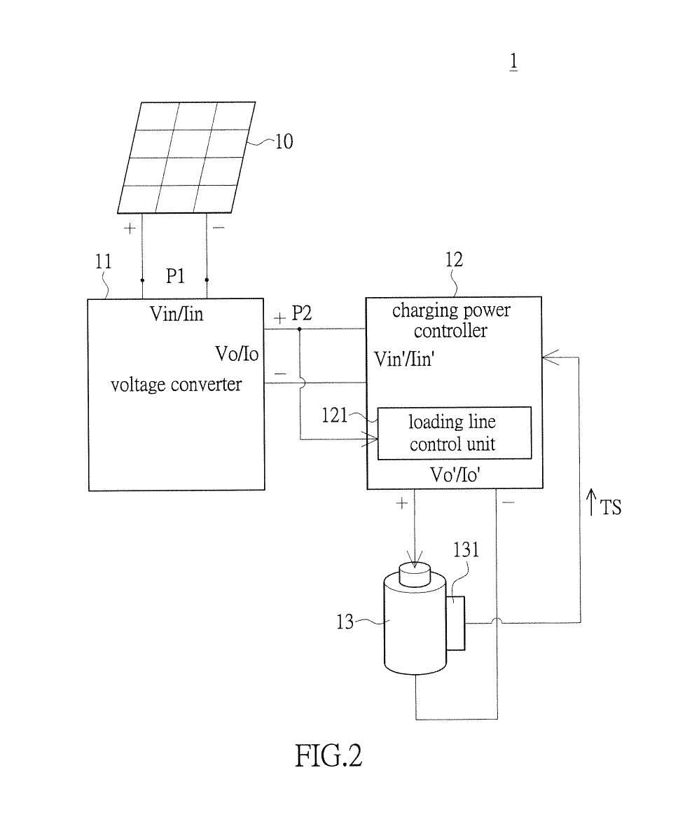

Please refer to FIG. 2 showing a circuit diagram of an adaptive solar energy harvesting device according to an embodiment of the instant disclosure. The adaptive solar energy harvesting device 1 comprises a solar energy receiving unit 10, a voltage converter 11 and a charging power controller 12. The solar energy receiving unit 10 usually is a solar panel having a plurality of solar cells. The adaptive solar energy harvesting device 1 transmits the electricity of the solar energy receiving unit 10 to at least an electricity storage unit 13. FIG. 2 only indicates an electricity storage unit 13; however the number of the electricity storage unit 13 may be plural.

The voltage converter 11 may be a boost converter or a buck converter. The voltage converter 11 has an input terminal P1 and an output terminal P2. The input terminal P1 of the voltage converter 11 is coupled to the solar energy receiving unit 10. The voltage converter 11 receives the electricity from the solar energy receiving unit 10 through the input terminal P1. The charging power controller 12 is coupled to the output terminal P2 of the voltage converter 11. The charging power controller 12 senses a supply voltage Vo of the output terminal P2 of the voltage converter 11 (wherein the input terminal Vin′ of the charging power controller 12 is also shown in FIG. 2), and generates a charging voltage Vo′ and a charging current Io′ to charge at least an electricity storage unit 13. The charging power controller 12 adjusts the charging current according the feed-forward control related to the supply voltage Vo at the output terminal P2 of the voltage converter 11. The mentioned feed-forward control may self-adjust the energy harvest of the solar panel and converts the energy to be stored in the chargeable energy storage unit (i.e. the electricity storage unit 13). Thus, no matter how much the harvested energy is, less or more energy could be stored as long as the harvested energy is larger than the energy consumption of the voltage converter 11 and the charging power controller 12.

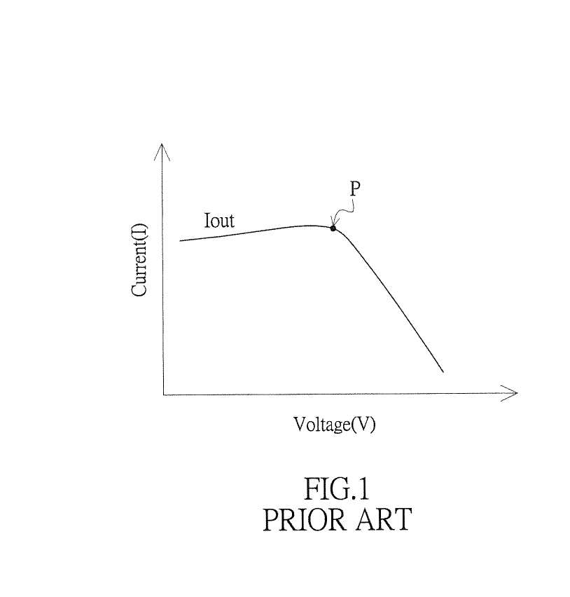

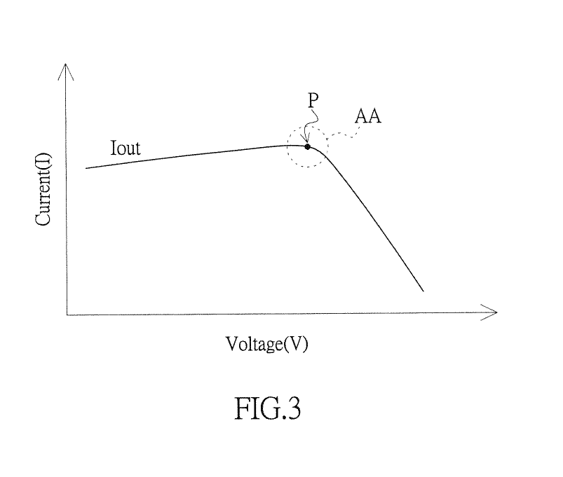

This embodiment utilizes the charging power controller 12 which has the capability to adaptive adjust the ability of harvesting energy according to the loading. For different intensity of the incident light, each solar cell has itself energy harvesting ability for outputting electricity. If the harvest load is not matched to output generation of solar cells then the output voltage of solar cells would collapse and drop to near ground or lower voltage values under heavy loading drain. To overcome such a problem it is proposed to have the loading forward adjustment to the output (post) stage of the photo-voltaic conversion the energy storage. Every boost or buck clock cycle from the harvested photo-voltaic into voltaic value the post stage which stores the harvested solar energy into electrochemical battery energy is automatically adjusted to accommodate the photo-voltaic output capability from delivered capability of former stage. Referring to FIG. 1, different from the Maximum Power Point Tracking (MPPT), this embodiment does not exactly track the maximum power transmission from the voltage converter 11 to the storage stage (which is the electricity storage unit 13). For this embodiment, it is using the adaptive cycle to cycle adjustment from the output capability of the voltage converter smoothly to deliver energy into the storage stage. As shown in FIG. 3, the adaptive solar energy harvesting device 1 makes the operating point be in the region AA around the maximum power point P. Although it is not exactly the maximum power delivery on the output loading line point of solar cells it is a full-range and close to maximum power delivery from solar cells into the electricity storage unit 13.

The electricity storage unit 13 usually is a secondary battery, such as the lithium nickel battery or the lithium-ion battery, but the instant disclosure is not so restricted. The electricity storage unit 13 is coupled to the charging power controller 12. The electricity storage unit 13 receives the charging voltage Vo′ and the charging current Io′ to be charged. The electricity storage unit 13 may a temperature sensory device 131. The temperature sensory device 131 senses the temperature of the electricity storage unit 13 and provides a temperature sensing signal TS to the charging power controller 12. The temperature sensory device 131 may provide the temperature sensing signal TS to indicate the charging power controller 12 to stop charging the electricity storage unit 13. Accordingly, over temperature of the electricity storage unit 13 could be avoided for safety.

The charging power controller 12 may adjust the loading line of charging the electricity storage unit 13 according to the supply voltage Vo when the adaptive solar energy harvesting device 1 charges the electricity storage unit 13. Detailed control manner could be referred to following descriptions.

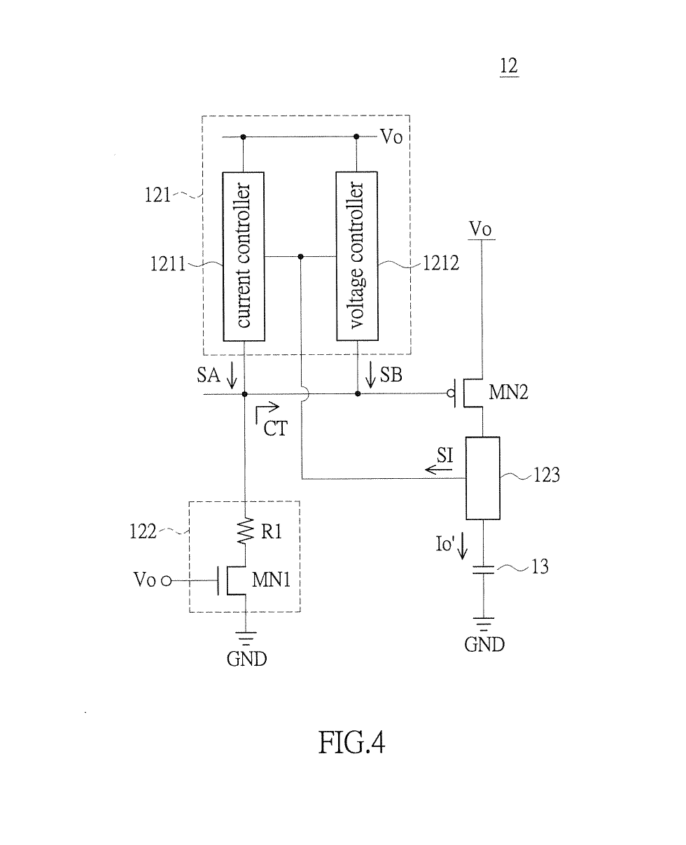

Please refer to FIG. 4 showing a circuit diagram of charging power controller according to an embodiment of the instant disclosure. The charging power controller 12, shown in FIG. 4, comprises a supply voltage sensing circuit 122 a power switch MN2, a loading line control unit 121 and a current sensing circuit 123. In one embodiment, the charging power controller 12 may only comprise the supply voltage sensing circuit 122 and the power switch MN2. The supply voltage sensing circuit 122 senses the supply voltage Vo, and generates a charging control signal CT according to the supply voltage Vo. The power switch MN2 has a first terminal, a second terminal and a control terminal, wherein the first terminal is coupled to the output terminal P2 of the voltage converter 11 for receiving the supply voltage Vo, the second terminal is coupled to the electricity storage unit 13 (through the current sensing circuit 123), the control terminal (for example, the gate electrode) is coupled to the supply voltage sensing circuit 122, the control terminal receives the charging control signal CT for adjusting the charging current Io′ passing through the power switch MN2. That is, the power switch MN2 is controlled by the charging control signal CT, in order to change the charging voltage Vo′ and the charging current Io′ for the electricity storage unit 13.

In one embodiment, the supply voltage sensing circuit 122 may comprise a transistor MN1 and a resistor R1. One terminal of the resistor R1 is coupled to the control terminal (e.g. the gate electrode) of the power switch MN2 and another terminal of the resistor R1 is coupled to a grounding GND through the transistor MN1, the transistor MN1 is controlled by the supply voltage Vo. The voltage across the transistor R1 is the charging control signal CT. In FIG. 4, the charging control signal CT may be the voltage level of the node of connecting the resistor R1 and the loading line control unit 121 that is the voltage level of the gate electrode of the power switch MN2. It is worth mentioning that the power switch MN2 and the supply voltage sensing circuit 122 is not so restricted.

In one embodiment, the charging power controller further comprises a current sensing circuit 123 and a loading line control unit 121. The current sensing circuit 123 senses the charging current Io′ of the electricity storage unit 13 to generate a current sensing signal SI. The loading line control unit 121 comprises a current controller 1211. The current controller 1211 is coupled to the supply voltage sensing circuit 122 and the current sensing circuit 123, wherein the current controller 1211 adjusts the charging control signal CT for adjusting the charging current Io′ passing through the power switch MN2. More specifically, the current controller 1211 may generate a first phase signal SA and adjust the charging control signal CT through the first phase signal SA. For example, the first phase signal SA generated by the current controller 1211 is the voltage level of the gate electrode of the power switch MN2, thus the voltage level of the node of connecting the resistor R1 and the gate electrode of the power switch MN2 is adjusted accordingly (for adjusting the charging control signal CT.

In one embodiment, the loading line control signal 121 further comprises a voltage controller 1212. The voltage controller 1212 is coupled to the supply voltage sensing circuit 122 and the current sensing circuit 123. The current controller 1211 generates a first phase signal SA to adjust the charging control signal CT when the charging current Io′ is not less than a threshold. The voltage controller 1212 generates a second phase signal SB to adjust the charging control signal CT when the charging current Io′ is less than a threshold.

The current sensing circuit 123 senses the charging current Io′ of the electricity storage unit 13 to generate a current sensing signal SI which is the basis for determining whether the charging current Io′ is less than the threshold. Generally, the current sensing circuit 123 may be a voltage divider which feedbacks the charging current Io′ to the current controller 1211 and the voltage controller 1212 of the loading line control unit 121 in voltage form, but the instant disclosure is not so restricted. For example, the current sensing signal SI varies according to the charging current Io′ when the current sensing circuit 123 feedbacks the charging current Io′ to the loading line control unit 121 in voltage form. The current controller 1211 and the voltage controller 1212 could determine whether the current signal SI is less than a threshold (in which the threshold may not the same as the threshold of the charging current Io′). Alternatively, the current sensing circuit 123 may trigger the current sensing signal SI when the charging current Io′ is less than a threshold, in which the current sensing signal SI disables the current controller 1211 and enables the voltage controller 1212. An artisan of ordinary skill in the art will appreciate how to implement the voltage controller 1212 and the current sensing circuit 123, thus there is no need to go into details.

Additionally, in order to make the charging power controller 12 have the circuit protection capability, the charging power controller 12 may comprise at least one of an over-voltage protection circuit, an over-current protection circuit, a short protection circuit and an over-temperature protection circuit. Therefore, the charging power controller 12 may have the capability of over-voltage protection, the over-current protection, the short protection and the over-temperature protection. The charging power controller 12 could monitor the charging status of the electricity storage unit 13 and maintain the safety of the electricity storage unit 13. An artisan of ordinary skill in the art will appreciate how to implement the over-voltage protection circuit, the over-current protection circuit, the short protection circuit and the over-temperature protection circuit, thus there is no need to go into detail.

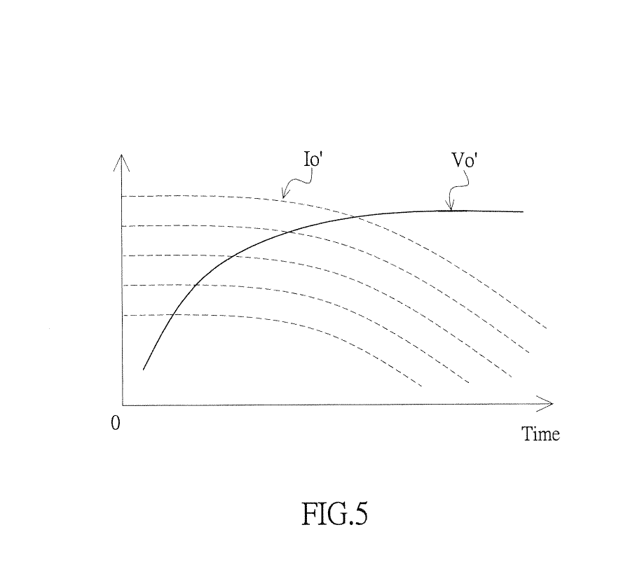

Please refer to FIG. 4 in conjunction with FIG. 5, FIG. 5 shows a curve diagram of the charging current and the charging voltage when the adaptive solar energy harvesting device charges the electricity storage unit according to an embodiment of the instant disclosure. When the electricity storage unit 13 is being charged, the current controller 1211 may adjust the charging control signal CT. The charging control signal CT is for adjusting the charging current Io′ passing through the power switch MN2. As shown in FIG. 5, the charging current Io′ (indicated as the dashed lines) is variable when the adaptive solar energy harvesting device 1 charges the electricity storage unit 13 (i.e. battery), in which the current controller 1211 may adjust the charging current Io′ (several dashed lines indicate the different charging currents Io′). Meanwhile, the electricity storage unit 13 may be at least one, for example, the electricity storage unit 13 is plural. Moreover, the electricity storage unit 13 usually utilizes electrochemical reaction to store electricity, and the charging current Io′ would decrease when the electricity storage unit 13 is close to be fully charged. Therefore, the current controller 1211 and the voltage controller 1212 shown in FIG. 5 could control the charging current Io′ and the charging voltage Vo′ respectively. In the beginning of charging the electricity storage unit 13, the current controller 1211 may generate a first phase signal SA to adjust the charging control signal CA, thus the charging current Io′ could be adjusted arbitrarily as needed. When the electricity storage unit 13 is close to be fully charged, the charging current Io′ would decrease gradually and the voltage of the electricity storage unit 13 would go up to a constant voltage, for example, the voltage of the fully charged lithium nickel battery is about to 4.2 volt, the voltage of the fully charged lithium-ion battery is about 3.3 volt. When the charging current Io′ degrades to a lower current limit (which could be predetermined), the charge power controller 12 could switch to charge the electricity storage unit 13 in a constant voltage. Meanwhile, the voltage controller 1212 generates a second phase signal SB to adjust the charging control signal CT. Specifically, during charging, the current sensing circuit 123 continuously senses the charging current Io′, and when the charging current Io′ decreases to a lower current limit the current sensing signal SI generated by the current sensing circuit 123 make the current controller 1211 stop outputting the first phase signal SA and make the voltage controller 1212 output a second phase signal SB for adjusting the charging control signal CT.

According to above descriptions, the aforementioned adaptive solar energy harvesting device utilizes feed-forward control to control the charging current and the charging voltage when charging the electricity storage unit, in order to convert and store electricity under low light incidence. The adaptive solar energy harvesting device provides the output capability of the voltage converter for smoothly delivering energy into the storage stage, and transmits the electricity in a full-range and close to maximum power delivery from solar cells into the storage stage.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An adaptive solar energy harvesting device, comprising:
a solar energy receiving unit;
a voltage converter, having an input terminal and an output terminal, the input terminal of the voltage converter coupling to the solar energy receiving unit, the voltage converter receiving the electricity from the solar energy receiving unit through the input terminal; and
a charging power controller, coupling to the output terminal of the voltage converter, sensing a supply voltage of the output terminal of the voltage converter and generating a charging voltage and a charging current to charge at least an electricity storage unit, wherein the charging power controller adjusts the charging voltage and the charging current according the feed-forward control related to the supply voltage at the output terminal of the voltage converter.

2. The adaptive solar energy harvesting device according to claim 1, wherein the charging power controller adjusts the loading line of charging the electricity storage unit according to the supply voltage when the adaptive solar energy harvesting device charges the electricity storage unit.

3. The adaptive solar energy harvesting device according to claim 1, wherein the charging power controller comprising:
a supply voltage sensing circuit, sensing the supply voltage, generating a charging control signal according to the supply voltage; and
a power switch, having a first terminal, a second terminal and a control terminal, the first terminal coupling to the output terminal of the voltage converter for receiving the supply voltage, the second terminal coupling to the electricity storage unit, the control terminal coupling to the supply voltage sensing circuit, the control terminal receiving the charging control signal for adjusting the charging current passing through the power switch.

4. The adaptive solar energy harvesting device according to claim 1, wherein the supply voltage sensing circuit comprises a transistor and a resistor, one terminal of the resistor is coupled to the control terminal of the power switch and another terminal of the resistor is coupled to a grounding through the transistor, the transistor is controlled by the supply voltage, and the voltage across the transistor is the charging control signal.

5. The adaptive solar energy harvesting device according to claim 3, wherein the charging power controller further comprises:
a current sensing circuit, sensing the charging current of the electricity storage unit to generate a current sensing signal; and
a loading line control unit, comprising a current controller, the current controller coupling to the supply voltage sensing circuit and the current sensing circuit, wherein the current controller adjusts the charging control signal for adjusting the charging current passing through the power switch.

6. The adaptive solar energy harvesting device according to claim 5, wherein the loading line control unit further comprises a voltage controller, the voltage controller is coupled to the supply voltage sensing circuit and the current sensing circuit, wherein the current controller generates a first phase signal to adjust the charging control signal when the charging current is not less than a threshold, the voltage controller generates a second phase signal to adjust the charging control signal when the charging current is less than a threshold.

7. The adaptive solar energy harvesting device according to claim 1, wherein the electricity storage unit further comprises a temperature sensory device, the temperature sensory device senses the temperature of the electricity storage unit and provides a temperature sensing signal to the charging power controller.

8. The adaptive solar energy harvesting device according to claim 1, wherein the solar energy receiving unit is a solar panel.

9. The adaptive solar energy harvesting device according to claim 1, wherein the electricity storage unit is a secondary battery.

10. The adaptive solar energy harvesting device according to claim 1, wherein the charging power controller comprises at least one of an over-voltage protection circuit, an over-current protection circuit, a short protection circuit and an over-temperature protection circuit.
